(19) United States
(12) Patent Application Publication
(10) Pub. No.: US 2023/0321939 A1
(43) Pub. Date: Oct. 12, 2023

(54) Continuous Case Blank Delivery System

(71) Applicant: Delkor Systems, Inc., St. Paul, MN (US)

(72) Inventor: Jeremiah Ericson, Andover, MN (US)

(73) Assignee: Delkor Systems, Inc., St. Paul, MN (US)

(21) Appl. No.: 17/716,854

(22) Filed: Apr. 8, 2022

(51) Int. Cl. B31B 50/06; B31B 50/00

(52) U.S. Cl. CPC B31B 50/066; B31B 50/005; B31B 2120/302

(57) ABSTRACT

A continuous case blank delivery system, its function and use are provided. The main components of the system include a staging area, an elevator area, a safety door positioned therebetween, and a carriage movable therebetween when the safety door is in the open position. The elevator has a right side wall a left side wall and an elevator platform. The platform is vertically moveable between a lowered position and a predetermined height. In the lowered position the elevator platform is below the height of the carriage. The walls each define a plurality of support finger housings, each of which contain an extendable support finger. When the elevator platform is in the lowered position each support finger is retracted and contained entirely within its housing. When the elevator reaches a predetermined height each support finger is extended.

### FIELD OF THE INVENTION

The present invention relates generally to a loading system for delivering case blanks to a case former that is capable of delivering blanks in a continuous, uninterrupted manner even during the process of reloading the system with case blanks.

### BACKGROUND OF THE INVENTION

With most known case forming machines (formers), the former relies on a reservoir or magazine of case blanks that are drawn or advanced into the former on an individual basis, whereupon the former forms the blank into a box, tray, case, etc., which is loaded with a product or products. Because case blank magazines have a finite size and capacity to hold case blanks, it will often be necessary during the case forming process to re-load the case blank magazine with additional blanks. This re-loading process often times results in the interruption of the case forming process, while the magazine is re-loaded. Such interruptions are inefficient and costly.

### SUMMARY OF THE INVENTION

Embodiments disclosed herein provide for a high capacity and continuous flat blank loading and delivery system, which is configured to allow for the continuous feed of blanks into a case former without any need to interrupt the case forming process even during the reloading of the case blank magazine.

Embodiments of the apparatus and system described herein utilize a moveable blank carriage having a blank staging area and a blank elevator.

Embodiments of the apparatus and system employ the carriage, elevator, and other components to provide for a continuous case blank delivery system that performs as follows:

A stack or magazine of case blanks is loaded onto the carriage at the staging area. The loaded carriage is then moved from the staging area into the blank elevator. The elevator, which includes a platform made up of a number of spaced prongs that support the magazine from below, is vertically moveable relative to an elevator housing or frame. Once the magazine is in the elevator, the elevator platform is raised to advance the stack of blanks off of the carriage toward a pick zone of a case former, where individual case blanks are shuttled from the magazine and into the case former. Once the elevator platform lifts the magazine of case blanks from the carriage, the carriage is returned to the staging area where a new magazine of case blanks may be loaded onto the carriage.

As case blanks are advanced into the case former, the number of case blanks present in the elevator is reduced. When a set number of case blanks remain in the elevator, the system deploys a number of support members or fingers between the spaced apart supports of the elevator platform to support this remaining number of case blanks. Once the remaining case blanks are supported by the fingers, the elevator platform returns to its original lowered position and the newly loaded carriage is advanced into the elevator to receive the new magazine of case blanks. The elevator platform then lifts the new magazine upward to interface with the remaining case blanks from the previous magazine and the fingers are retracted, thereby allowing the case blanks of the new magazine to seamlessly join the stack of case blanks remaining in the elevator from the first magazine without any need to pause or otherwise interrupt the flow of case blanks from the elevator to the former.

A more complete description of the embodiments disclosed herein, as well as their individual components, function and advantages are shown in the following drawings and described in the detailed description below.

### BRIEF DESCRIPTION OF THE DRAWINGS

FIG. 1 is a loading-side perspective view of a continuous case blank delivery apparatus.

FIGS. 2 and 3 are the same view as FIG. 1, showing case blanks being loaded onto the carriage at the staging area.

FIG. 4. is the same view as shown in FIG. 3, with the safety door that separates the staging area from the elevator during the blank loading process shown in an open position.

FIGS. 5 and 6 are the same as view shown in FIG. 4, depicting the fully loaded carriage being slid from the staging area into the elevator, through the open safety door.

FIG. 7 is the same view as shown in FIG. 6, depicting the case blank magazine having been deposited on the elevator platform and the carriage returned to the staging area through the open safety door.

FIG. 8 is the same view as shown in FIG. 7, wherein the safety door is shown in the closed position.

FIG. 9 is the same view as shown in FIG. 8, depicting the vertical (upwards) movement of the elevator platform during case blank delivery.

FIG. 10 is a schematic side view of the embodiment shown in FIG. 9.

FIG. 11 is a perspective view of the embodiment shown in FIGS. 1-10, wherein as a result of case blank delivery, only a limited number of case blanks from a first magazine of case blanks remain on the elevator platform, while a second magazine of case blanks has been loaded onto the carriage within the staging area.

FIG. 12 is a close-up, underside perspective view of the elevator platform and case blanks shown in FIG. 11 prior to the deployment of the support fingers.

FIG. 13 is the same view as shown in FIG. 1 and provided to illustrate the position and deployment of support fingers that are deployed when the limited number of case blanks such as are shown in FIG. 11 (but not shown in this image) remain on the elevator platform.

FIG. 14 is a close-up, underside perspective view of the elevator platform and case blanks shown in FIG. 12, and with the support fingers shown in their extended or deployed position.

FIG. 15 is an alternative, close-up, underside perspective view of one wall of the elevator (specifically the wall that supports the elevator platform) shown in FIG. 14, illustrating the relative position of the extended finger supports to the spaced apart platform members of the elevator platform.

FIG. 16 is the same view as FIG. 15 with the elevator platform not shown (having been lowered from the case blank magazine, now supported by the extended support fingers).

FIG. 17 is a detailed perspective view of the elevator wall of the embodiment shown in FIGS. 15-16 with the case blanks removed from the image to better illustrate the relative position of the finger support channels (housings) and the platform members of the elevator platform.

FIG. 18 is a detailed perspective view of the elevator wall of the embodiment shown in FIG. 17 with the support fingers shown in the extended or deployed position.

FIG. 19 is a loading-side perspective view of the continuous case blank delivery apparatus as shown in FIGS. 1-18, illustrating the lowering of the elevator platform following extension of the support fingers to maintain support of the remaining case blanks of a first magazine, while a second magazine of case blanks is loaded onto the carriage within the staging area.

FIG. 20 is the same view as in FIG. 19, but with the second magazine shown ready for transition into the elevator through the open safety door.

FIG. 21 is the same view as in FIG. 20, where the second magazine is positioned on the elevator platform (not visible).

FIG. 22 is the same view as in FIG. 21, and showing the second magazine being raised by the elevator platform (not visible) following the return of the carriage to the staging area and the closing of the safety door.

FIG. 23 is the same view as in FIG. 22, illustrating retraction of the support fingers as the second magazine is raised into positioned for blank delivery.

### DETAILED DESCRIPTION

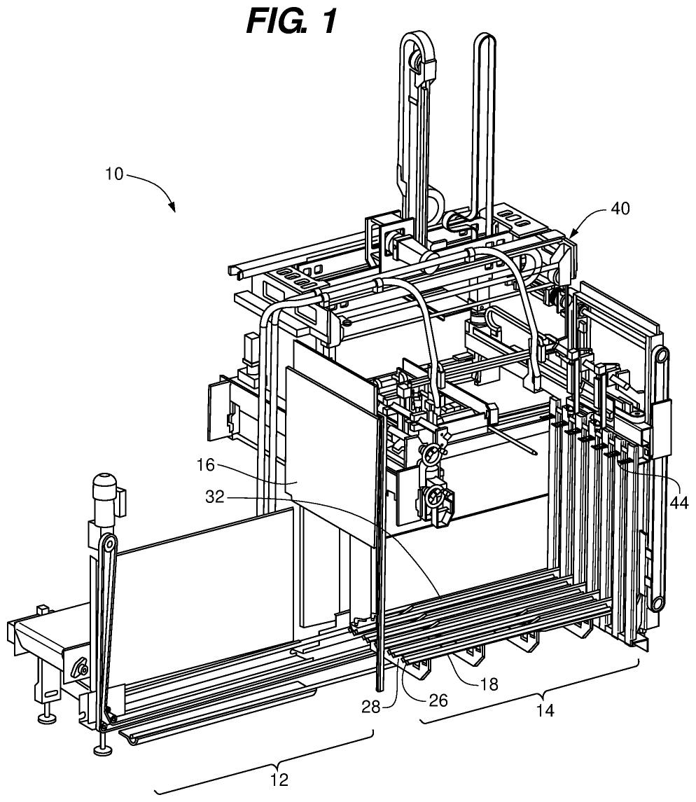

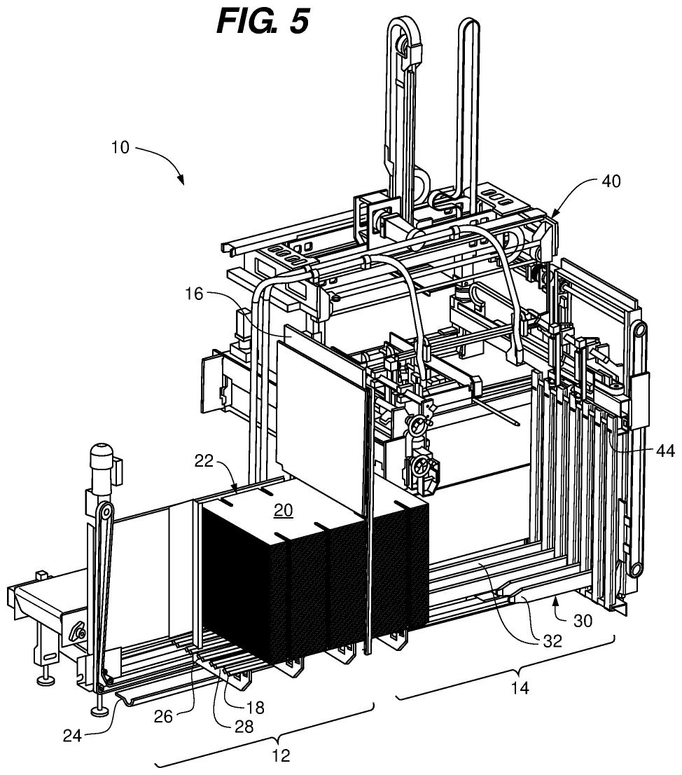

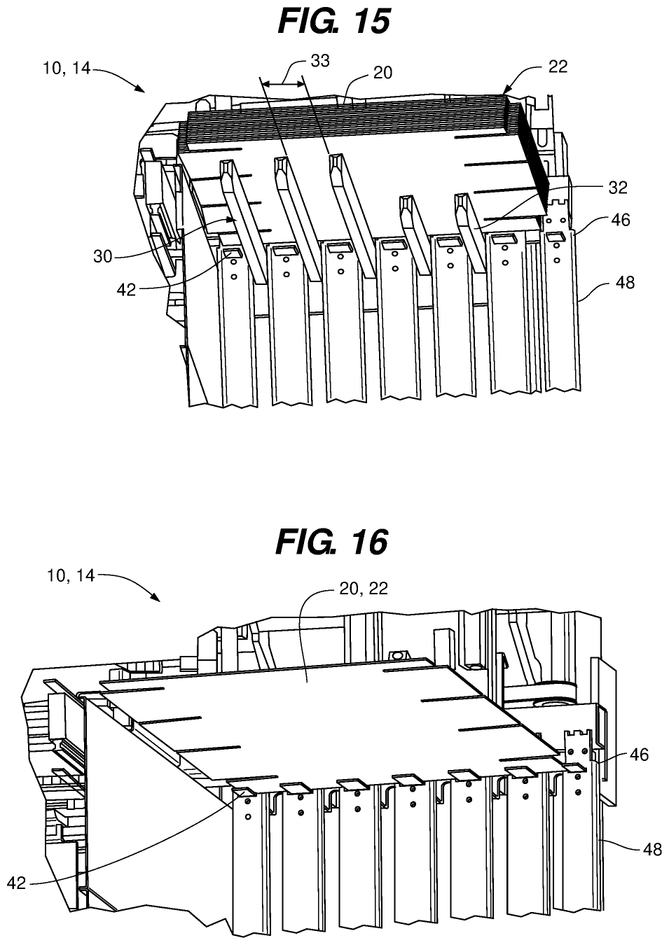

As mentioned above, embodiments disclosed herein provide for a high capacity and continuous flat blank loading and delivery system, which is configured to allow for the continuous feed of blanks into a case former without interruption. Aspects of the continuous case blank delivery system (the system) are shown in FIGS. 1-23.

The system 10, shown in FIG. 1 may be considered to have two primary components or areas, namely a staging area 12 and an elevator area 14. The staging area 12 is separated from the elevator area 14 by a safety door 16. A slidable carriage 18 is movable between the staging area 12 and elevator area 14 when the safety door 16 is in the open position, such as is shown in FIG. 1,

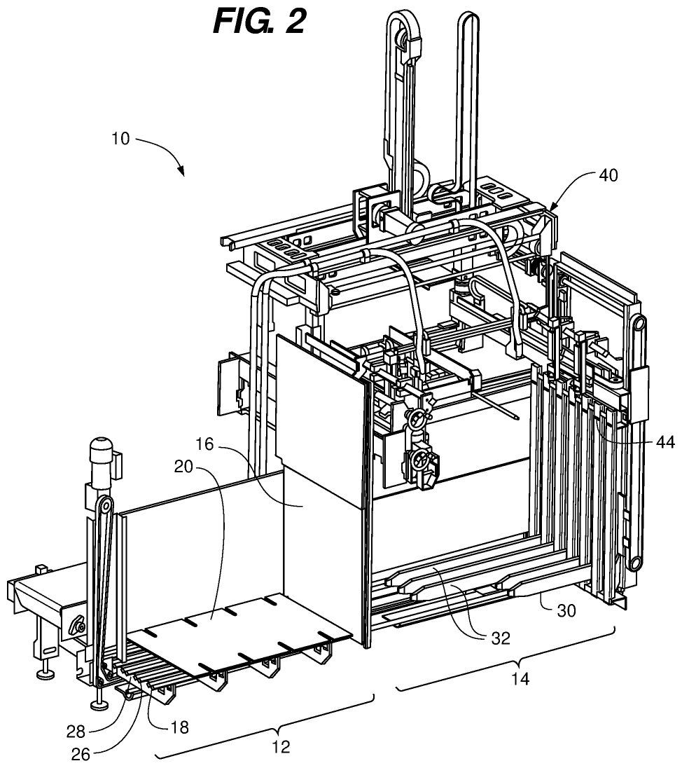

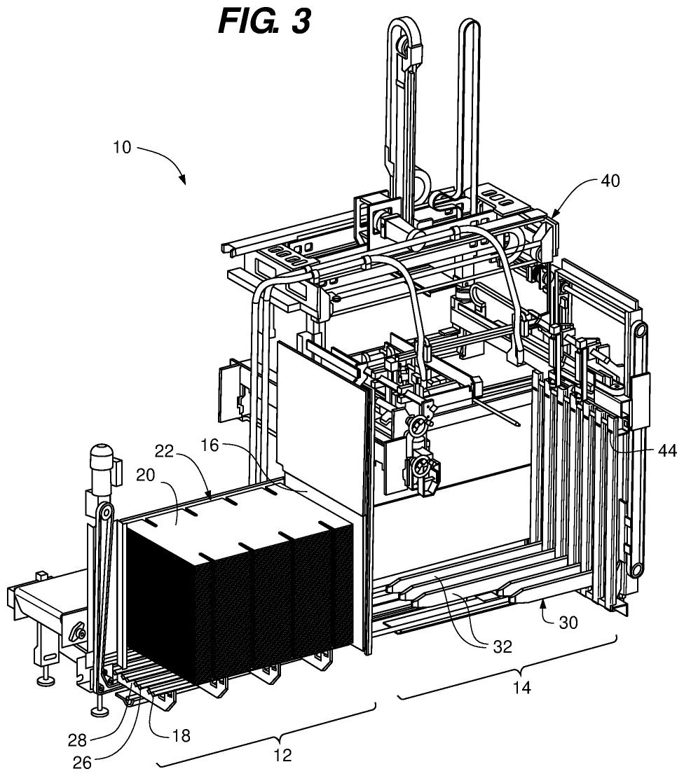

In the default state (before activation of the system 10) shown in FIG. 2, the carriage 18 is positioned in the staging area 12 where it may receive one or more case blanks 20. Case blanks 20 may be loaded on to the carriage 18 individually (one at a time), such as in the manner shown in FIG. 2, or may be loaded in bulk, in the form of a case blank magazine 22 such as is shown in FIG. 3.

The size, shape, and blank loading capacity of the staging area 12 and carriage 18 may vary in different embodiments, but typically, the staging area 12 and carriage 18 will be configured to be capable of accepting a blank magazine 22 of between 250-500 blanks 20.

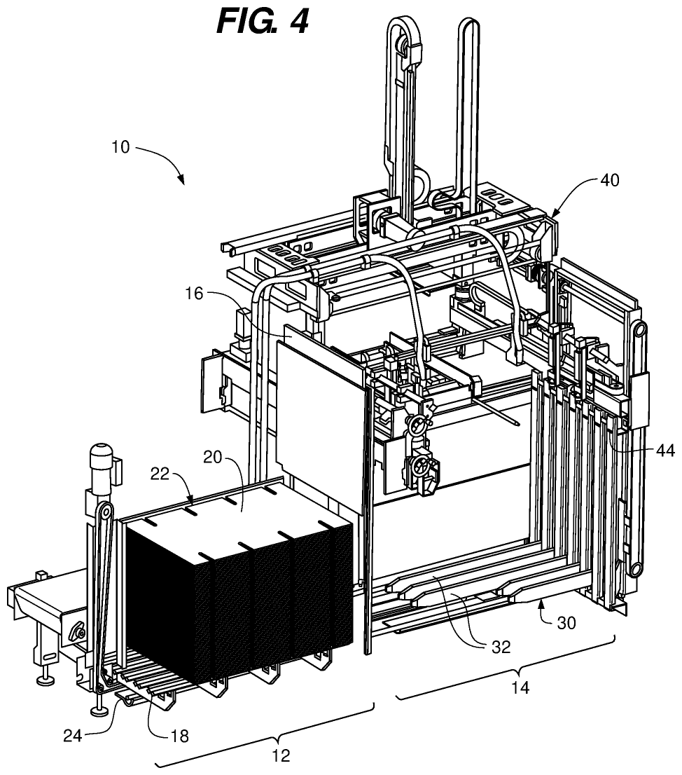

Once the carriage 18 is loaded to the desired extent with case blanks 20, the safety door 16 is opened and the loaded carriage 18 is advanced along slide rails 24 into the elevator area 14 in the manner shown in FIGS. 4-6.

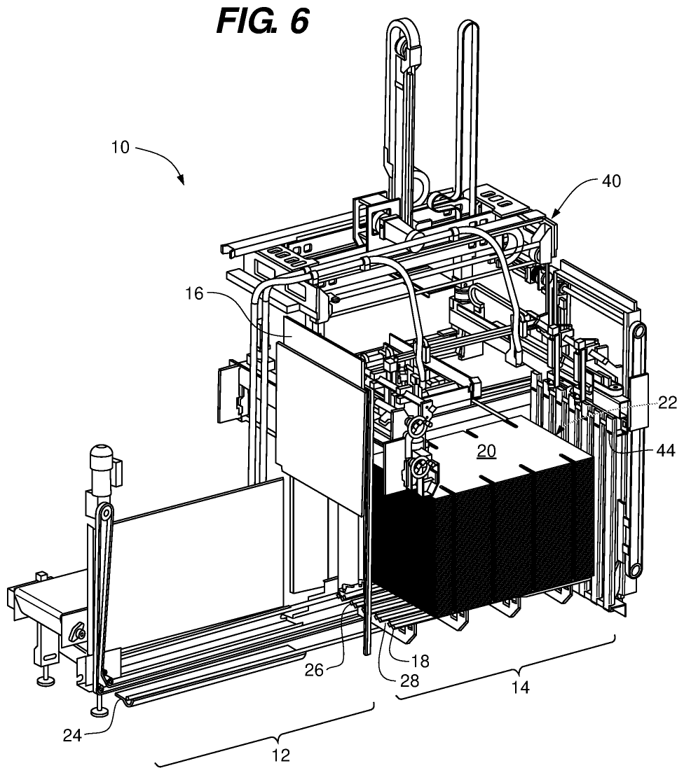

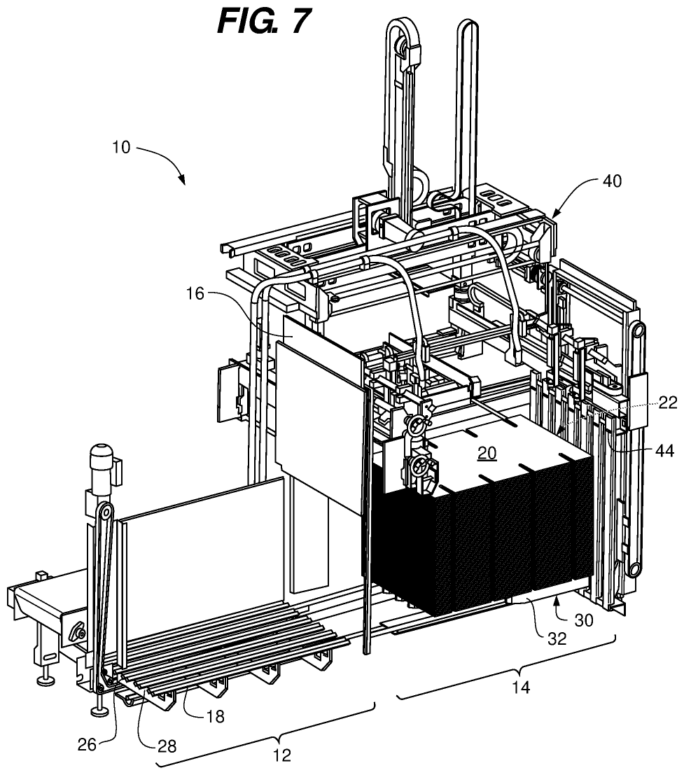

When properly positioned in the elevator area 14, the blank magazine 22 is lifted off of the carriage 18 by an elevator platform 30, and the carriage 18 is returned to the staging area 12, such as in the manner shown in FIG. 7. As may be seen in the various figures, the carriage 18 is not a solid platform, but rather is comprised of a series of spaced apart, parallel support members 26. The spaces 28 between each support member 26 are sized to allow one of a plurality of elevator prongs 32 which make up the elevator platform 30 to be positioned when the elevator platform is in the lowered state shown in FIGS. 1-6 (elevator platform 30 and prongs 32 not visible in FIG. 6).

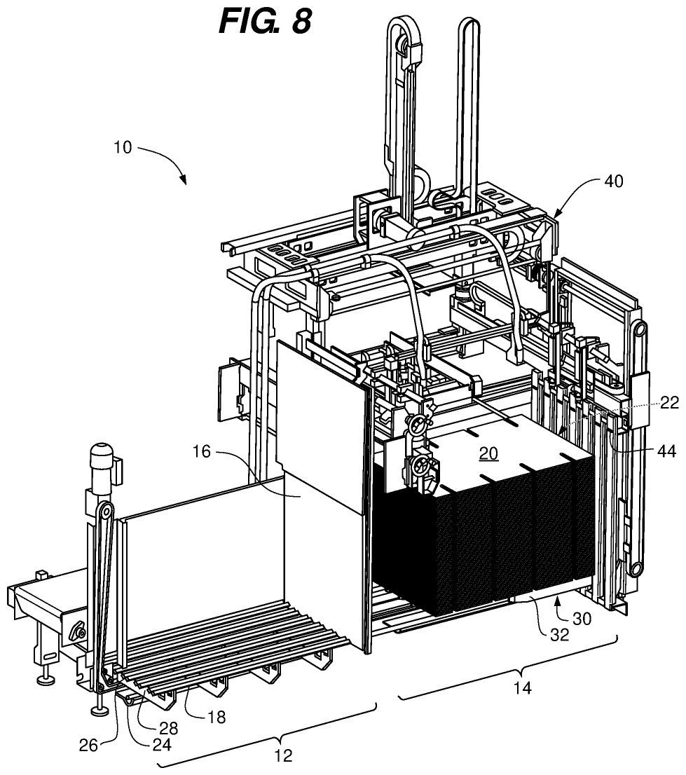

The system 10 detects when the carriage 18 has entered the elevator area 14 and that the carriage 18 is in position over the elevator platform 30, such as in the manner shown in FIG. 7. When the carriage 18 is properly positioned over the elevator platform 30, the system 10 initiates the elevator platform 30 to advance vertically (rise) to an extent sufficient to engage the blank magazine 22 and take its weight off of the carriage 18. This is made possible by the unique arrangement of spaced apart elevator platform prongs 32 being positioned between the spaced apart support members 26 of the carriage 18 (See FIG. 1). When the elevator platform 30 is initiated, the prongs 32 pass between the support members 26 to lift the blank magazine off of the carriage 18. Once the blank magazine 22 is lifted off of the carriage 18, the carriage 18 returns to the staging area 12, and the safety door 16 is returned to its closed position, such as in the manner shown in FIG. 8.

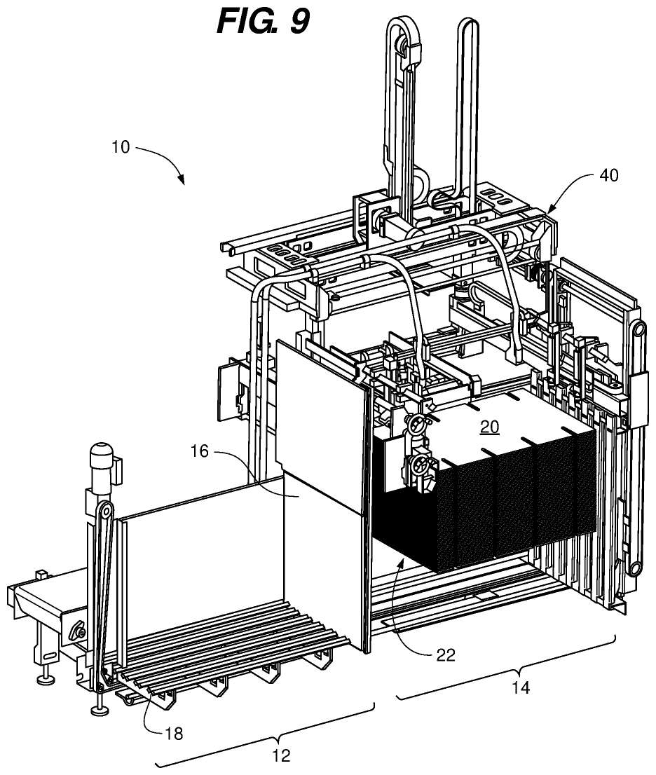

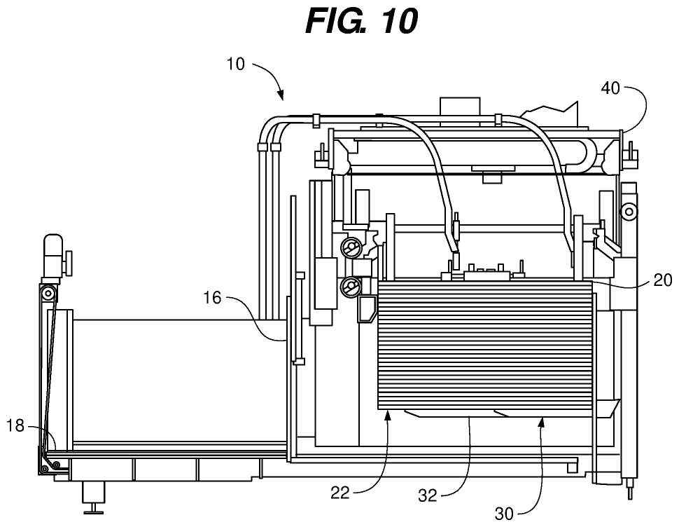

As shown in FIGS. 9-10, the system 10 detects when the carriage 18 has returned to the staging area 12 and the safety door 16 has closed. Once the safety door 16 is closed, the system 10 activates the elevator platform 30 (not visible beneath magazine 22) to vertically advance in a continuous and regulated manner, so as to bring the first blank 20 of the magazine 22 into the operational range of a blank shuttle system 40. The blank shuttle system 40 is positioned over the elevator area 14 and is configured to remove individual case blanks 20 from the magazine 22 and shuttle the removed blank 20 into a case former (not shown). The vertical movement of the elevator platform 30 is synchronized with the operation of the blank shuttle system 40, such that the blank shuttle system 40 removes the individual case blanks 20 from the magazine 22 and a new case blank 20 is always in position and ready to be shuttled.

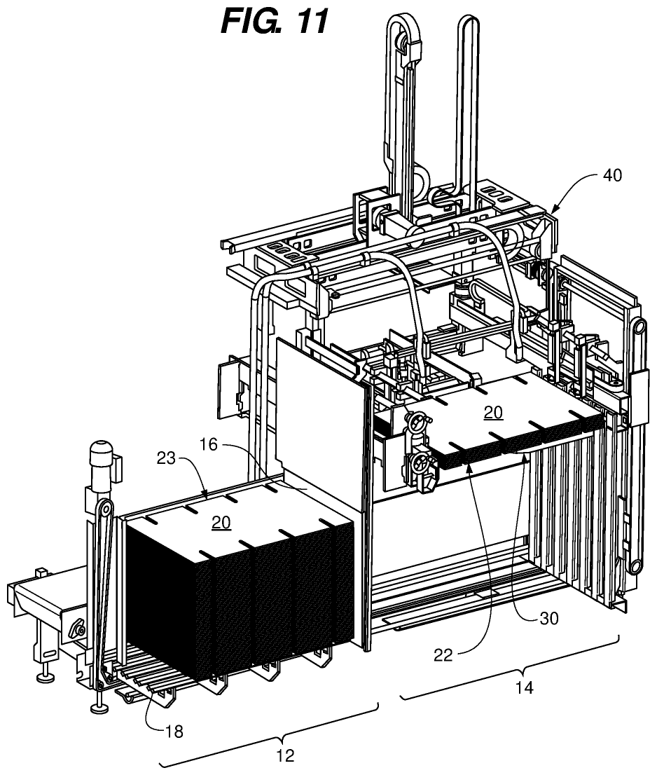

While a first magazine 22 of case blanks 20 is being advanced into the case former via movement of the elevator platform 30 and actuation of the blank shuttle system 40, a second magazine 23 may be loaded onto the carriage 18 within the staging area 12, such as in the manner shown in FIG. 11.

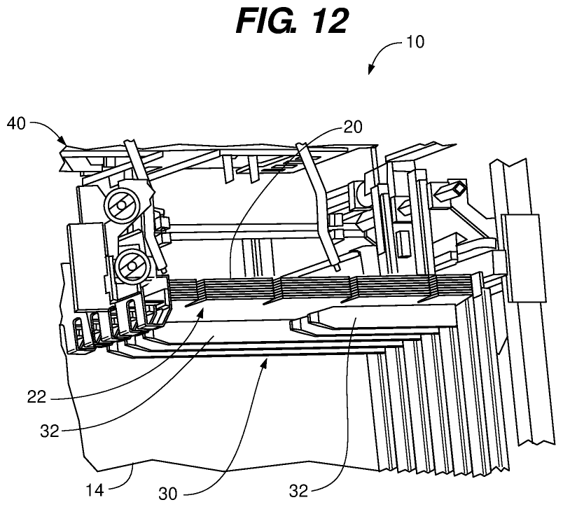

As is shown in FIG. 11, the second magazine 23 cannot yet be advanced into the elevator area 14 because the remaining blanks of the first magazine 22 remain supported and continue to be vertically advanced by the elevator platform 30, such as in the manner shown in FIG. 12.

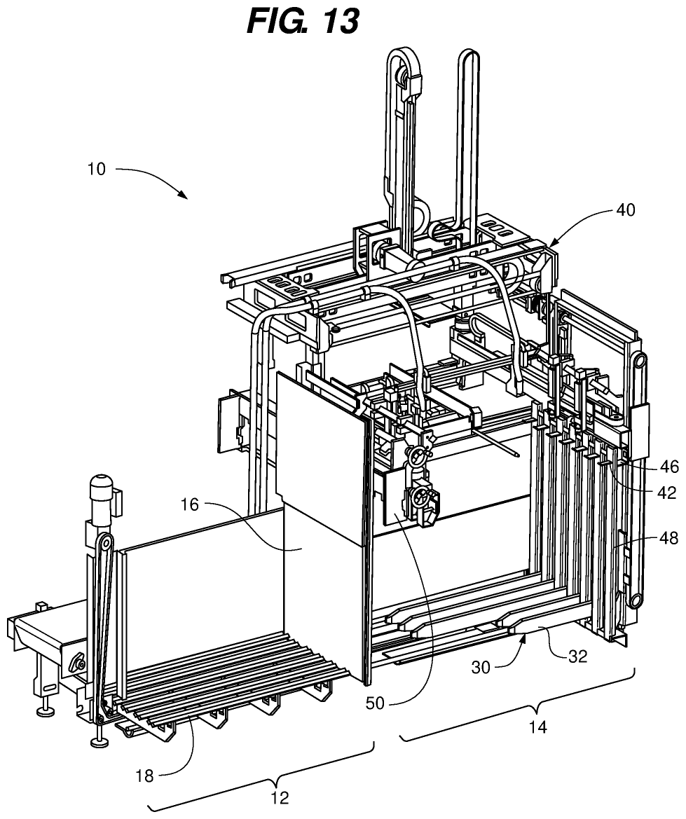

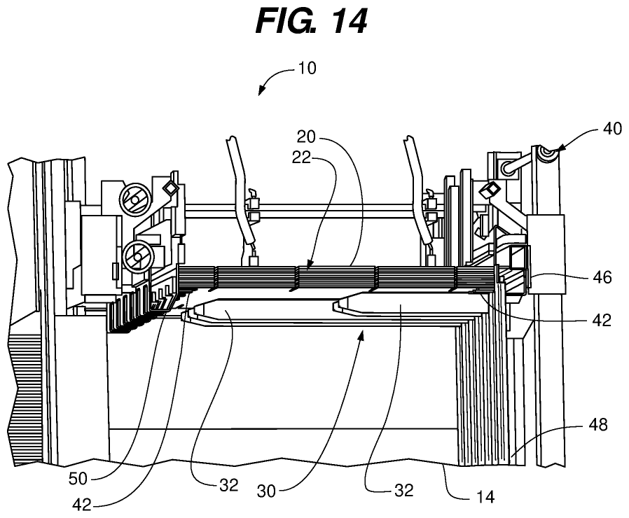

To allow the elevator platform 30 to return to its original lowered position, such as is shown in FIG. 13, the system 10 includes blank support fingers 42, which normally remain in a retracted position within finger housings 44 (housings 44 being visible in FIGS. 1-9) that are located at a predetermined height 46 from the lowered position of the elevator platform 30 on the right side wall 48 and left side wall 50 (fingers 42 on the left side wall are visible in FIG. 14) of the elevator area 14, but which are extended from within the housings 44 when the system 10 detects that the elevator platform 30 has reached a predetermined height 46, or that a specific number of blanks 20 remain on the elevator platform 30 (such as by weight or remaining height of the magazine). When the fingers 42 are extended by the system 10, they extend together and to a length sufficient to support the remaining blanks 20 of the first magazine 22, in the manner shown in FIGS. 14-16. When the fingers 42 are extended, the system 10 signals the elevator platform 30 to return wo the lowered position shown in FIG. 13.

The function and configuration of the fingers 42 is best shown in FIGS. 14-19, which show a close-up view of the right side (aka: the elevator side) wall 48 of the elevator area 14. Starting with FIG. 14, in this image the elevator platform 30 is shown having reached the predetermined height 46 and the fingers 42 have been extended beneath the remanent of the first magazine 22. Once the fingers 42 are extended, the system 10 directs the elevator platform 30 to vertically descend or lower (i.e., return to its lowered position such as is shown in FIG. 13).

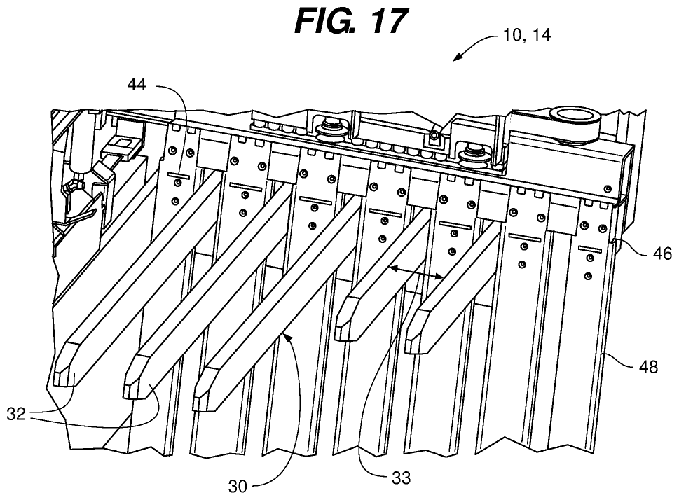

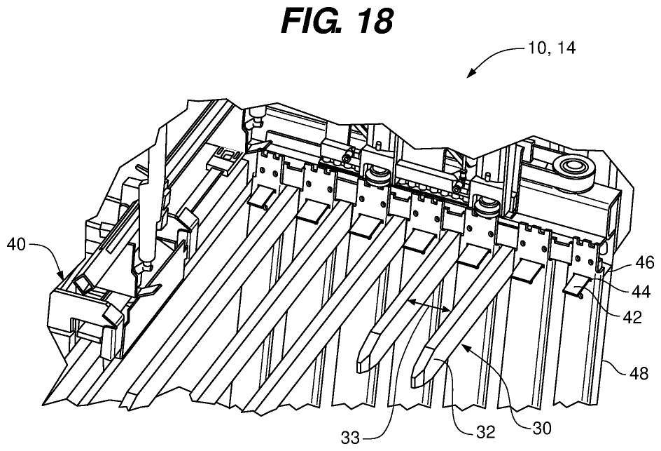

As is shown in the various figures, the fingers 42 and finger housings 44 (best shown in FIG. 17) are positioned along the walls (only right side wall 48 being presented here) of the elevator area 14 at locations which correspond to the spaces or gaps 33 between the prongs 32 of the elevator platform 30. As such, when the elevator platform 30 is lowered, the remanent of the first magazine 22 is deposited onto the extended fingers 42. The remaining blanks 20 of the first magazine 22 remain accessible to the blank shuttle system while supported by the fingers 42. As shown in FIG. 16, the fingers 42 remain extended as long as a blank 20 remains from the first magazine 22.

The position of the finger housings 44 relative to the prongs 32 of the elevator platform 30 are shown in FIG. 17 (with the blank magazine 22 removed from view). Likewise, the position of each of fingers 42 in the extended position (fingers 42 extending from the housings 44) relative to the prongs 32 of the elevator platform 30 are shown in FIG. 18 (with the blank magazine 22 removed from view).

When the first magazine 22 is depleted (all the blanks 20) have been removed from their position on the fingers 42, each finger 42 is retracted back into its finger housing 44.

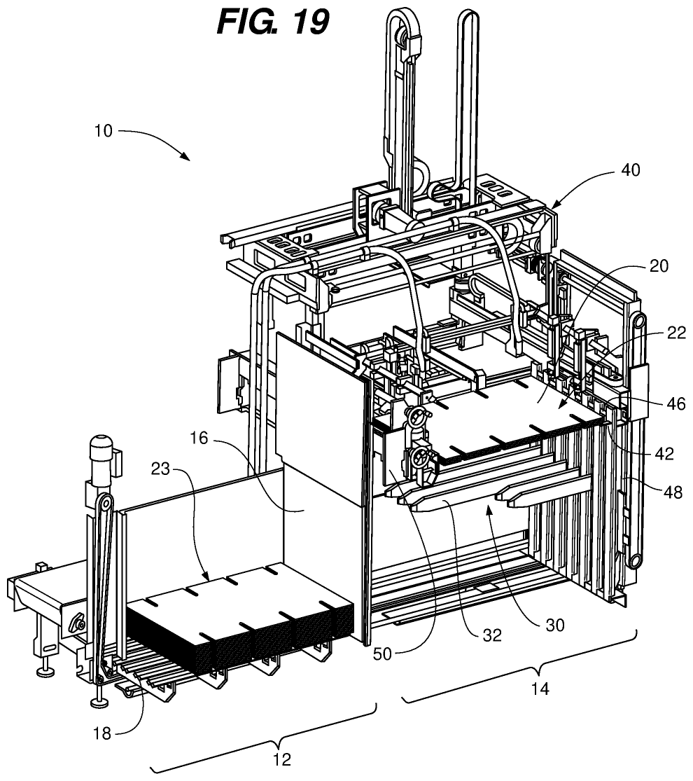

By extending finger 42 to support a remanent of a first blank magazine 22, and thereby allow the elevator platform 30 to return to its original lowered position while the blanks 20 of the first magazine continue to be fed into a case former the present system may be allowed to operate continuously, such as is demonstrated by the sequence of images provided in FIGS. 19-22.

Starting with FIG. 19, once the fingers 42 are extended to support the remaining blanks 20 of the first magazine 22, the elevator platform 30 begins to descend back to its original lowered position. Before or during this stage, the carriage 18 positioned in the staging area 12, may be reloaded with a second magazine of blanks 23.

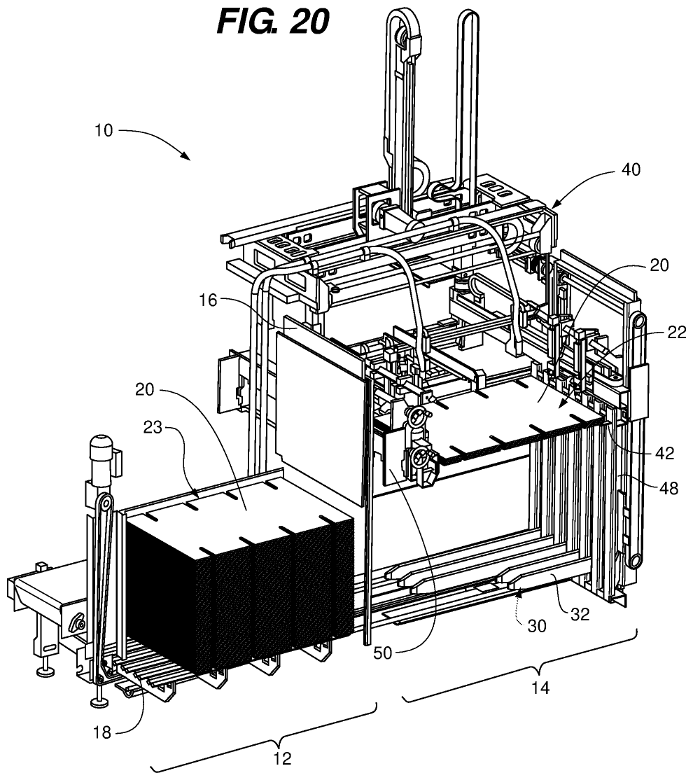

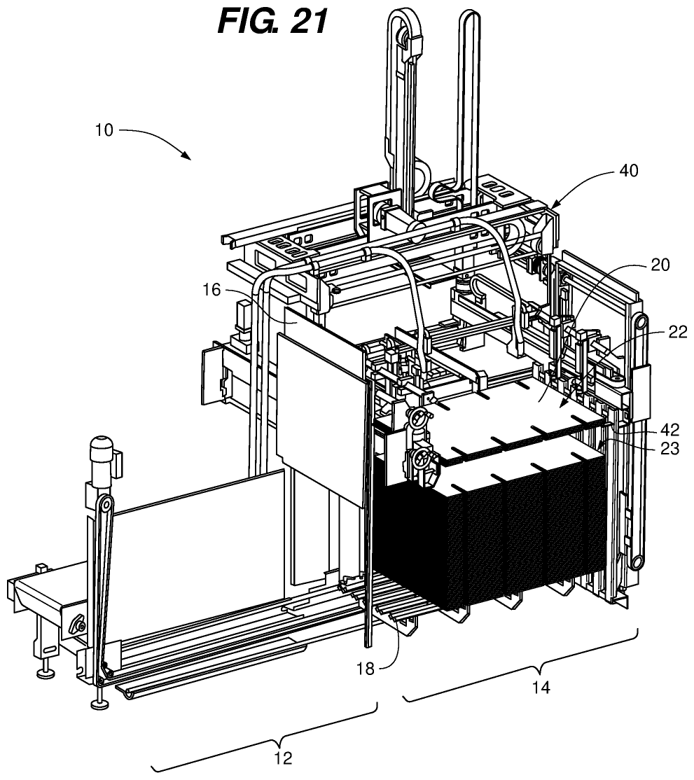

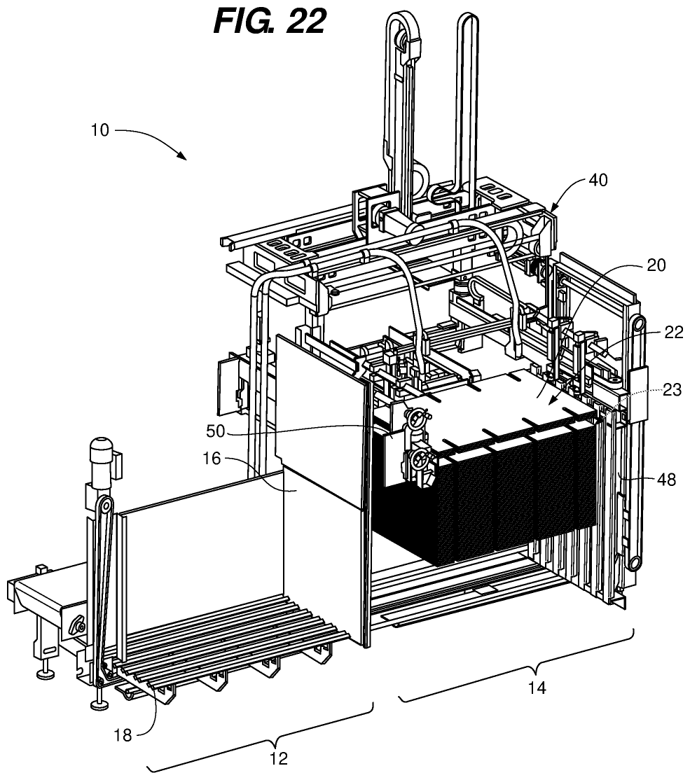

When the carriage 18 is fully loaded, and the elevator platform 30 returned to its original lowered position, such as is shown in FIG. 20, the safety door 16 is opened, and the carriage 18, along with the second magazine 23 of blanks 20, is advanced into the elevator area 14. While the loaded carriage 18 transitions through the open safety door 16, the blank shuttle system 40 continues to shuttle blanks 20 of the first magazine 22 into the case former, such as in the manner shown in FIG. 21.

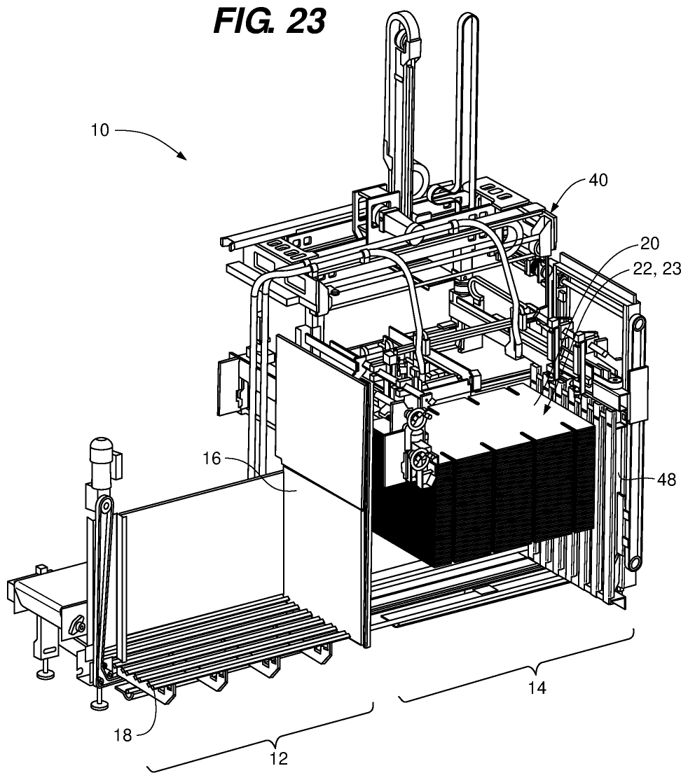

As shown in FIG. 22, when the second magazine 23 is properly positioned over the elevator platform 30, the elevator platform 30 is activated to lift the second magazine 23 vertically upward and off of the carriage 18 and toward any remaining blanks 20 of the first magazine 22. Once the second magazine 23 is lifted off of the carriage 18, the now empty carriage 18 returns to the staging area 12 and the safety door 16 is closed.

As shown in FIG. 23, as the elevator platform 30 lifts the second magazine 23 vertically upward, the fingers 42 will be retracted into housings 44. If any remaining blanks 20 of the first magazine (see FIG. 22) remain in the elevator area 14, the retraction of the fingers 42 will deposit the remaining first magazine blanks 20 onto the top of the second magazine 23. The blanks 20 of the second magazine 22 are then positioned for shuttling and case formation in the same manner as the blanks of the first magazine. The first magazine and second magazine processing and loading process as depicted in the figures and described above, may be repeated without interruption, with subsequent magazine blanks for any period desired or as limited by routine maintenance requirements.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A continuous case blank delivery system comprising:
a staging area, an elevator area, a safety door positioned between the staging area and the elevator area and having an open position and a closed position, and a carriage movable between the staging area and the elevator area when the safety door is in the open position;
the elevator area being defined by a right side wall a left side wall and an elevator platform, the elevator platform being vertically moveable between a lowered position and a predetermined height, in the lowered position the elevator platform being positioned lower than the carriage;
the left side wall and the right side wall each defining a plurality of support finger housings, each of the support finger housings containing a support finger, each support finger being movable between a retracted position and an extended position, in the retracted position each support finger being entirely contained within one of the support finger housings, in the extended position each support finger extending into the elevator area, each support finger being in the retracted position when the elevator platform is in the lowered position, each support finger being placed in the extended position when the elevator platform is raised to the predetermined height.

2. The system of claim 1, wherein the elevator platform is comprised of a plurality of prongs, adjacent prongs being separated by a first space.

3. The system of claim 2, wherein the carriage is comprised of a plurality of support members, adjacent support members being separated by a second space.

4. The system of claim 3, wherein each second space is configured to allow one of the plurality of prongs to pass between adjacent support members, and each first space is configured to allow one of the plurality of support members to pass between adjacent prongs.

5. The system of claim 4, wherein each of the plurality of support finger housings on the right side wall is located at a housing location, each housing location being within each first space.

6. The system of claim 5, further comprising a first magazine, the first magazine being defined by a plurality of case blanks.

7. The system of claim 6, further comprising a blank shuttle system, the blank shuttle system being positioned over the elevator area and configured to shuttle each of the plurality of case blanks from the first magazine into a case former.

8. The system of claim 7, wherein the blank shuttle system receives the plurality of case blanks from the first magazine according to the following steps:
loading the first magazine onto the carriage when the carriage is positioned in the staging area and the safety door is in the closed position;
opening the safety door;
advancing the carriage and first magazine into the elevator area to position the carriage and first magazine over the elevator platform;
raising the elevator platform from the lowered position, each prong of the elevator platform passing through one of the second spaces between the adjacent support struts of the carriage to engage the first magazine and lift the first magazine from the carriage;
returning the carriage to the staging area;
closing the safety door;
continuing to raise the elevator platform to bring the first magazine into operational range of the blank shuttle system, the blank shuttle system shuttling each of the plurality of blanks from the first magazine and into a case former as the elevator platform rises;
extending the support fingers from the retracted position to the extended position when the elevator platform reached the predetermined height;
lowering the elevator platform, the first blank being supported by the support fingers in the extended position; and
returning the elevator platform to the lowered position.

9. The system of claim 8, further comprising the steps of:
following the returning of the carriage to the staging area and the closing of the safety door, loading a second magazine onto the carriage;
opening the safety door when the elevator platform has returned to the lowered position;
advancing the carriage and second magazine into the elevator area to position the carriage and second magazine over the elevator platform;
raising the elevator platform from the lowered position, each prong of the elevator platform passing through one of the second spaces between the adjacent support struts of the carriage to engage the second magazine and lift the first magazine from the carriage;
returning the carriage to the staging area; and
closing the safety door.

10. The system of claim 9, further comprising the steps of:
continuing to raise the elevator platform to bring the second magazine into a position adjacent to any remaining blanks of the first magazine;
retracting the support fingers from the extended position to the retracted position; and
continuing to raise the elevator platform to bring the second magazine into operational range of the blank shuttle system, the blank shuttle system shuttling each of the plurality of blanks from the second magazine and into the case former as the elevator platform rises.
